(19) United States
(12) Patent Application Publication
(10) Pub. No.: US 2020/0042702 A1
(43) Pub. Date: Feb. 6, 2020

(54) Device, Method, and System for Synthesizing Variants of Semantically Equivalent Computer Source Code to Protect Against Cyber-Attacks

(71) Applicant: United States Government as represented by the Secretary of the Navy, San Diego, CA (US)

(72) Inventor: Stuart H. Rubin, San Diego, CA (US)

(73) Assignee: United States of America as represented by Secretary of the Navy, San Diego, CA (US)

(21) Appl. No.: 16/053,258

(22) Filed: Aug. 2, 2018

(51) Int. Cl. G06F 21/56; G06F 8/30; G06N 5/04

(52) U.S. Cl. CPC G06F 21/563; G06F 2221/033; G06N 5/04; G06F 8/30

(57) ABSTRACT

First and second computer source codes are generated by a case-based inference engine based on first and second parameters received via a user interface. The first and second parameters are different but are both associated with a desired result. The second computer source code is generated as a semantically equivalent variant of the first computer source code to provide for protection against a cyber-attack.

### FEDERALLY-SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif., 92152; telephone (619) 553-5118; email: ssc pac t2@navy.mil, referencing Navy Case 103845.

### FIELD OF THE INVENTION

The present disclosure pertains generally to cyber-security. More particularly, the present disclosure pertains to protecting against cyber-attacks using computer-generated variants of semantically equivalent computer source codes.

### REFERENCE TO A SEQUENCE LISTING

An example embodiment of cyber-secure code is included in a text file named “103845_cpl_computer_program_listing.txt”, hereinafter referred to as the CPL text file, which was created, and submitted to the United States Patent and Trademark Office via the Electronic Filing System, on 2 Aug. 2018. The CPL text file is 48 kilobytes in size and is incorporated by reference herein in its entirety.

### BACKGROUND OF THE INVENTION

The number of computational devices using embedded software is rapidly increasing. Also, the functional capabilities of embedded software are becoming increasingly complex each year.

With the increase in complexity of software systems comes a problem of cyber-security. For complex interactions across software components and subsystems, a great number of lines of source code is needed. Such source code is not only prone to errors but is increasingly becoming the target of cyber-attacks. It is not generally possible to produce fault-free source code, and attackers have shown the ability to find and exploit residual faults and use them to formulate cyber-attacks.

It is not unusual to find substantially similar software in today's software systems. As a result, successful cyber-attacks can impact a large number of installations running similar software.

Conventionally, cyber-attacks are detected by detecting viral signatures which indicate that a cyber-attack has occurred. However, this approach is not sufficiently effective, especially as software becomes highly distributed across many processors.

More recent approaches attempt to detect a cyber-attack before any recoverable damage occurs. One such approach involves the use of syntactic diversification. This approach uses distinct compilers to create distinct object codes from the same source code. While this approach is somewhat effective, it will only succeed against at most one version of object code. However, as cyber-attacks grow in their sophistication, they can succeed against multiple versions of object code simultaneously.

In view of the above, it would be desirable to address shortcomings of conventional approaches for providing protection of computer systems against cyber-attacks.

### SUMMARY OF THE INVENTION

According to illustrative embodiments, first and second computer source codes are generated by a case-based inference engine based on first and second parameters, respectively. The first and second parameters are received via a user interface. The first and second parameters are different but are both associated with a desired result. The second computer source code is generated as a semantically equivalent variant of the first computer source code to provide for protection against a cyber-attack.

These, as well as other objects, features and benefits will now become clear from a review of the following detailed description, the illustrative embodiments, and the accompanying drawings.

### BRIEF DESCRIPTION OF THE DRAWINGS

Features of illustrative embodiments will be best understood from the accompanying drawings, taken in conjunction with the accompanying description, in which similarly-referenced characters refer to similarly-referenced parts, and in which:

FIG. 1 illustrates an example of a cyber-secure automatic programming system according to an illustrative embodiment.

FIG. 2 depicts an example of cases stored in a case database according to an illustrative embodiment.

FIG. 3 illustrates a flow chart showing steps in a process for synthesizing semantically equivalent variants of computer source code to provide for protection against a cyber-attack according to an illustrative embodiment.

FIG. 4 illustrates a flow chart showing steps in a process for dynamically selecting cases in groups for transformation using a 3-2-1-R skew according to an illustrative embodiment.

FIG. 5 illustrates a computing device that may be used in a cyber-secure automatic programming system according to an illustrative embodiment.

### DETAILED DESCRIPTION OF THE EMBODIMENTS

According to illustrative embodiments, variants of semantically equivalent computer source code are used for cyber-security. Distinct but equivalent computer source codes are synthesized to provide for protection against a cyber-attack.

According to illustrative embodiments, variants of computer source code may be synthesized through the piecewise decomposition of complex algorithms into more or less granular cases that are amenable to independent and parallel processing in a case-based inference engine. This is far easier than having coders write a diverse set of complex algorithms. Also, this allows for massive parallel-processing which speeds up synthesis and also autonomously extends and generalizes cases to better serve the purpose(s) intended by the original complex algorithm(s).

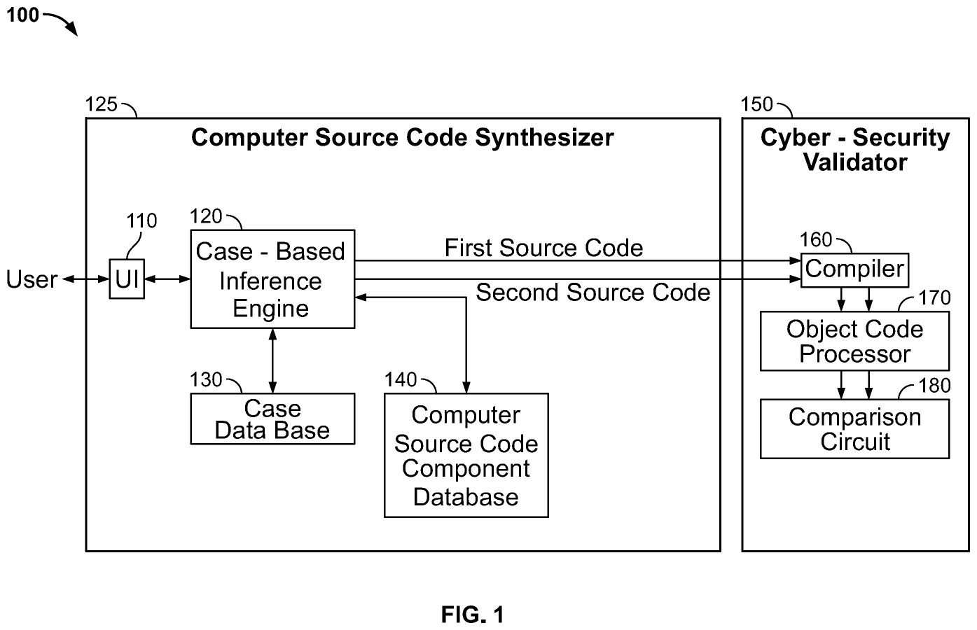

FIG. 1 illustrates an example of a cyber-secure automatic programming system according to an illustrative embodiment. As shown in FIG. 1, the cyber-secure automatic programming system 100 includes a computer source code synthesizer 125 and a cyber-security validator 150. The computer source code synthesizer 125 is in wired or wireless communication with the cyber-security validator 150. The cyber-security validator 150 may be included as part of the cyber-secure automatic programming system 100 as depicted in FIG. 1 or may exist as a separate system.

The computer source code synthesizer 125 synthesizes computer source code based on user-specified parameters received via a user interface (UI) 110. The user interface 110 is configured to receive different parameters that are associated with the same desired result. For example, the user interface 110 receives a first parameter associated with a desired result from a user and a second parameter associated with the same desired result from the same user or a different user. These parameters may be received responsive to a computer-generated query issued by, for example, the case-based inference engine 120. The desired result may be a user-selected or computer-specified result of an operation to be performed by a processor, such as a sort of numbers or characters. The user interface 110 may be implemented with any suitable user interface, such as a microphone, a keypad, a touchscreen, etc.

The computer source code synthesizer 125 includes a case-based inference engine 120 that includes at least one processor. The case-based inference engine 120 is configured to generate different but semantically equivalent computer source codes based on received parameters. For example, the case-based inference engine 120 generates first computer source code and second computer source code based on the first parameter and the second parameter, respectively. The second computer source code is a semantically equivalent variant of the first computer source code.

While a cyber-attack may succeed against one of the generated computer source codes, it is highly unlikely that an attack will succeed against multiple variants of the computer source code. Thus, generating semantically equivalent variants of computer source code provides for protection against cyber-attacks.

According to one embodiment, synthesized semantically equivalent variants of computer source code are intended to produce the same desired result when compiled and executed. Any difference between the results of two or more non-deterministic syntactic variants of computer source code is an indication that a cyber-attack has occurred or is occurring. This is described in further detail below.

The case-based inference engine 120 generates computer source code using cases stored in a case database 130. The case database 130 is configured to store a plurality of cases including situations paired with associated actions. The stored cases may be populated ahead of time by mapping natural language (NL) inputs to case semantics. The stored cases are updated as appropriate during a “dream mode” of the cyber-secure automatic programming system 100 by the case-based inference engine 120, as described in further detail below.

A case includes a “left hand side” (LHS) situation (or set of situations) and a right hand side (RHS) action (or sequence of actions). Each LHS situation and RHS action are defined by predicates. A LHS predicate is a Boolean query, and a RHS predicate is a sequential action. Thus, when the LHS situation is true, the case is “fired”, i.e., one or more computer source code components associated with the case are selected for assembly into a computer source code as described in further detail below.

The case-based inference engine 120 selects cases having associated context from the case database 130 based on the received parameters. For example, for a given context (which may be predetermined by the computer source code synthesizer 125 or may be provided by a user via the user interface 110), the case-based inference engine 120 selects at least one first case associated with a first parameter from the case database 130 and selects at least one second case associated with a second parameter from the case database 130. The second case(s) is/are different than the first case(s). The first case(s) and the second case(s) are associated with first computer source code components and second computer source code components, respectively. These computer source components are stored, along with other computer source code components, in a computer source code component database 140 that is configured to store a plurality of computer source code components.

The case-based inference engine 120 is configured to generate computer source code using the computer source code components associated with the selected cases. For example, the case-based inference engine 120 selects the first computer source code components associated with the first case(s) and assembles the first computer source code components into the first computer source code. The case-based inference engine 120 also selects the second computer source code components associated with the second case(s) and assembles the second computer source code components into the second computer source code. The second computer source code is different than but semantically equivalent to the first computer source code. That is, the second computer source code is a semantically equivalent variant of the first computer source code.

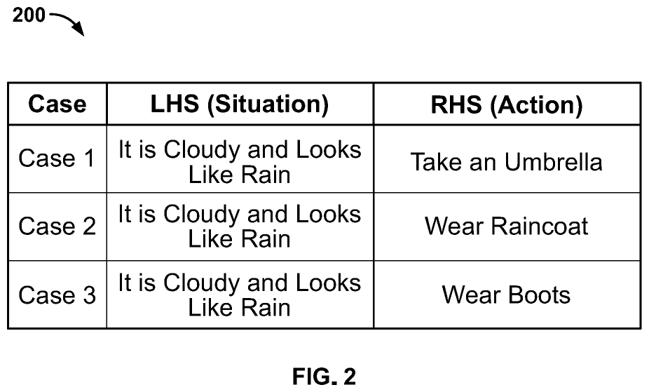

As an example, consider a set of cases such as that shown in the table 200 depicted in FIG. 2. This set of cases includes RHS actions that are fired when associated paired LHS situations are true, based on a given context and received parameters. According to an illustrative embodiment, the cases are grouped by RHS actions. Case 1 includes the association of the LHS situation “It is cloudy and looks like rain” with the RHS action “Take an umbrella”. Case 2 includes the association of the LHS situation “It is cloudy and looks like rain” with the RHS action “Wear raincoat”. Case 3 includes the association of the LHS situation “It is cloudy and looks like rain” with the RHS action “Wear boots”.

The case-based interference engine 120 selects cases from the case database 130 based on received parameters by matching cases in the case database 130 with a given context and configuring matched cases based on the received parameters. Assume, with reference to FIG. 2, that a given context is “It is cloudy and looks like rain” and that a desired result is to “Not get wet”. Parameters may include “Minimize chance of clothes getting wet” and “Minimize chance of feet getting wet”. With just the given context information, any of the cases (Case 1, Case 2, or Case 3) may be selected for firing, such that the end result to “Not get wet” is achieved. Based on the received parameter “Minimize chance of clothes getting wet”, Case 1 and Case 2 would be selected for firing. Based on the received parameter “Minimize chance of feet getting wet”, Cases 1 and Case 3 would be selected for firing.

As can be seen from this example, the context is used to find the cases with matching situations in the case database 130, and the received parameters are used to configure the cases, where that is an option. If no parameters are received, any of the cases may be selected as long as the situation “It is cloudy and looks like rain” is true to achieve the desired result to “Not get wet”. In this way, received parameters vary what cases are fired.

As noted above, the cases are associated with computer source code components stored in the computer source code component database 140. When a case is selected from the case database 130, i.e., when one or more cases are fired, the case-based inference engine 120 selects the computer source code components associated with the fired case(s) from the computer source code component database 140 and assembles the selected computer source code components into computer source code. Referring to the example described above with reference to FIG. 2, when Case 1 and Case 2 are selected by the case-based inference engine 120 based on the received parameter “Minimize chance of clothes getting wet”, first computer source code is formed from computer source code components associated with Case 1 and Case 2. Similarly, when Case 1 and Case 3 are selected by the case-based inference engine 120, second computer source code is formed from computer code components associated with Case 1 and Case 3.

Firing a case in a group results in the whole group being moved to the logical head of a list in the case database 130. Similarly, recouping space results in expunging a Least-Recently Used (LRU) group off the tail.

As noted above, the case-based inference engine 120 generates computer source code through the assembly of computer source code components that are associated with cases selected from a case database 130. Although one case-based inference engine 120 is shown in FIG. 1, it should be appreciated that massively parallel (distributed) processors may store and simultaneously search for matching cases in the case database 130 to find a best match.

While the case database 130 cannot be logically subdivided because a best partial match often needs to be found from among all cases, a very probable ratio is sufficient to interrupt a search. A search is terminated for a perfect match.

Referring again to FIG. 1, a cyber-security validator 150 (which may be part of the cyber secure automatic programming system 100 or may exist separately) includes at least one compiler 160. The compiler 160 is configured to compile computer source code generated by the case-based inference engine 120 to produce object code. The cyber-security validator 150 also includes at least one object code processor 170 configured to execute the object code. For example, the compiler 160 compiles the first computer program source code and the second computer program source code generated by the case-based inference engine 120 to produce first object code and second object code, respectively. The processor 170 then executes the first object code and the second object code to produce a first result and a second result, respectively.

The cyber-security validator 150 further includes a comparison circuit 180 that is configured to compare results of execution of object code to determine whether a cyber-attack has occurred or is in progress. For example, the comparison circuit 180 compares the first result and the second result and determines whether there is a difference between the first result and the second result. If there is a difference between the first result and the second result, the comparison circuit 180 determines that a cyber-attack has occurred or is in progress. If the first result and the second result are the same, the comparison circuit 180 determines that a cyber-attack has not occurred. As noted above, it is highly unlikely that a cyber-attack will affect both the first computer source code and the second computer source code. However, using the cyber-security validator 150 to detect a cyber-attack through a comparison of results of compiled and executed computer source codes adds another layer of protection against cyber-attacks.

It should be appreciated that a cyber-attack may be detected at intermediate stages, before compilation and execution. For example, in the case of first and second computer source codes configured to produce a sort of numbers, a cyber-attack may be detected by examining the first and second computer source codes generated by the case-based inference engine 120 to determine what information is to be sorted, before a sort is executed. If the both the first computer source code and the second computer source code indicate that numbers are to be sorted, then the assumption is that a cyber-attack has not occurred at this stage. If, however, either the first computer source code or the second computer source code indicate that information other than numbers is to be sorted, then it may be determined that a cyber-attack has occurred or is in progress. Detection of a cyber-attack at intermediate stages may be performed by a processor that is part of or external to the computer source code synthesizer 125.

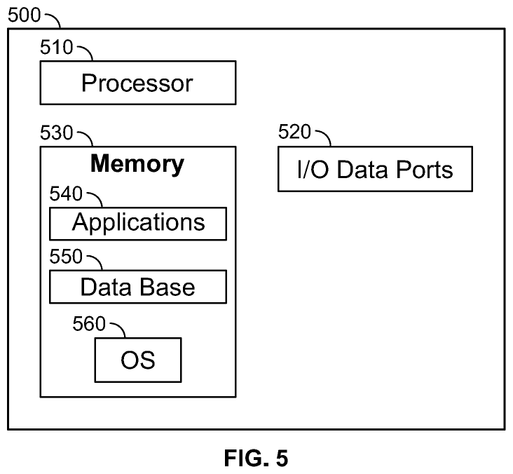

Components of the cyber-secure automatic programming system 100 may be included in one or more computing devices, such as the computing device 500 shown in FIG. 5 and described in more detail below.

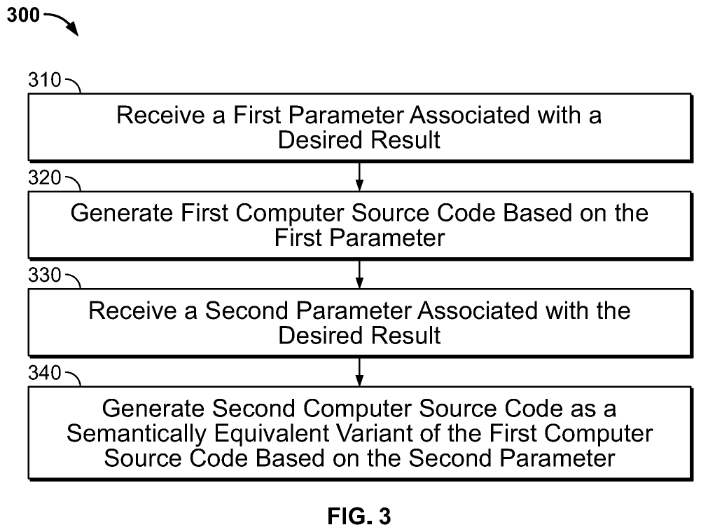

FIG. 3 illustrates a flow chart showing steps in a process for synthesizing semantically equivalent variants of computer source codes to provide for protection against cyber-attacks according to an illustrative embodiment. It should be appreciated that the steps and order of steps described and illustrated are provided as examples. Fewer, additional, or alternative steps may also be involved and/or some steps may occur in a different order.

Referring to FIG. 3, the process 300 begins at step 310 at which a first parameter associated with a desired result is received from a user via, e.g., a user interface, such as the user interface 110 shown in FIG. 1. At step 320, first computer source code is generated based on the first parameter. This step may be performed by, e.g., the case-based inference engine 120 shown in FIG. 1 and described above. As described above, the first computer source code may be generated by selecting at least one first case associated with first computer source code components based on the first parameter.

At step 330, a second parameter associated with the desired result is received via the user interface. At step 340, second computer source code is generated, e.g., by the case-based inference engine 120, based on the second parameter. As described above, the second computer source code may be generated by selecting at least one second case associated with second computer source code components based on the second parameter.

The second parameter is different from the first parameter, such that the second computer source code is generated as a semantically equivalent variant of the first computer source code to provide for protection against a cyber-attack. Further, once the first computer source code and the second computer source code are compiled and executed to produce a first result and a second result, respectively, a cyber-attack may be detected simply by comparing the first result and the second result. If there is a difference between the first result and the second result, this means that a cyber-attack has occurred.

Having explained how different computer source codes are synthesized using the case based inference engine 120, an explanation is now provided as to how the case database 130 may be populated.

Initially, the case database 130 may be populated with cases by mapping Natural Language (NL) input to case semantics. This mapping may be performed by a mapper (not shown) using translated NL inputs. As new cases are acquired, these new cases are added to the case database.

From time to time, cases needed to be updated. For example, a RHS action may need to be corrected. In this scenario, if a LHS situation is exactly matched by a case in a group, then correcting the associated RHS action results in this LHS being deleted and a new case being acquired by the appropriate new group. The former group is expunged if only its header remains. If no such group exists, it is created. The entire group is moved to the logical list head of groups upon the acquisition or firing of a case. More specific LHS situations are subsumed and expunged from the group. Also, duplicate cases are expunged from the group whenever they occur. Deleting subsumed cases leaves the general case, which is a randomization of the deleted case.

If the LHS situation is fuzzily (i.e., incompletely) matched, then correcting a RHS action results in a new case being acquired by the appropriate new group.

As noted above, cases are stored with paired associated LHS situations and RHS actions. As further noted above, the LHS situations and the RHS actions are defined by predicates. In some cases, there may be predicate duality, in which case the same predicates have closely related meanings in terms of LHS situations and the paired RHS actions. This duality allows the number of cases stored in the case database 130 to be expanded and/or generalized during “dream mode”, while the cyber-secure automatic programming system 100 is idle, to cover new situations and apply new actions.

During dream mode, the cases in the case database 130 are expanded and/or generalized by applying cases to transform other cases, such that the resulting LHS situations in the group are not subsumed, lest they be expunged. The goal of transformation is to create new compact cases which are deemed to be valid if they do not contradict an existing case.

Transformation may be understood using the following example. Let a randomly selected case in a first group be “a b→c d”, where the situation “a b” is paired with the action “c d”. Let a randomly selected case in a second group be “a b→e”, where the situation “a b” is paired with the action “e”. This second case applies to the first case with a contraction on “a b” with the result, e→c d. The first case applies to the second case with the result c d→e. However, this is not a contraction.

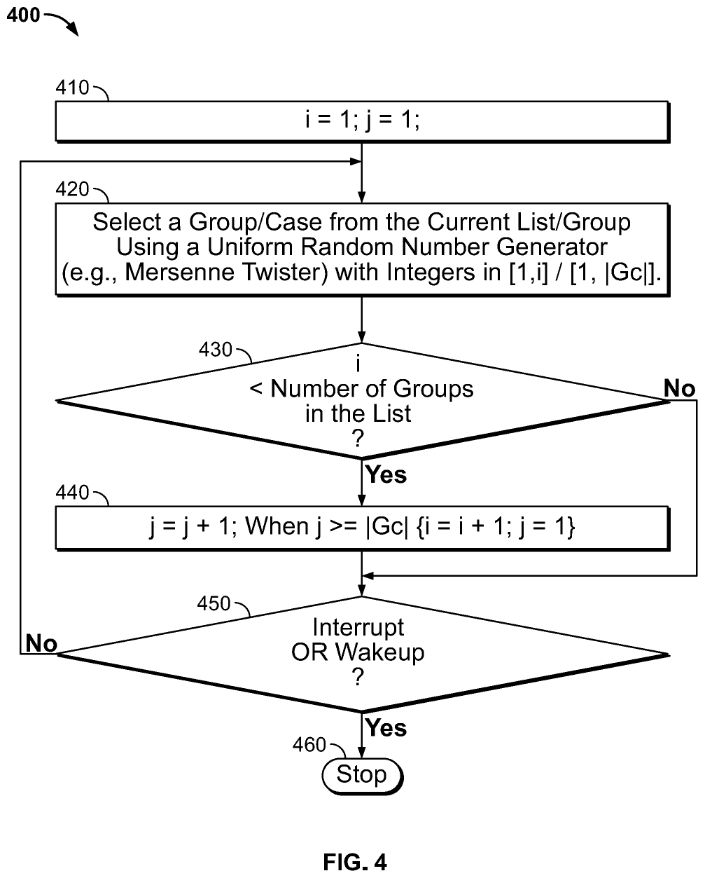

In dream mode, a uniform skew or a 3-2-1-R skew (explained below with reference to FIG. 4) may be used to select case groups to be paired for transformation. A randomly selected case in the first selected group is applied to a randomly selected case in the second selected group. The number of groups participating in the skew is incremented, up to the total number of groups, when the number of randomly selected situations since the last increase in the skew size is greater than or equal to the current group size.

Transformations apply in both directions to the selected cases' LHS situations and RHS actions, with transformations resulting in net contractions to at least one side. This constraint serves to prevent unnecessary and runaway computations. The LHS situation must be ordered to enable ordered transformation of the RHS action as a result of duality.

Transformed RHS actions are checked for duplication against all other groups. If a duplication is found, the groups are unified at the logical head, after testing each pairing of constituent group LHS situations for subsumption.

Predicates may pose questions which may be provided as queries via the user interface 110. The answers to such questions augment the context, which then becomes a candidate for logical contraction. Randomization of the context insures that a minimum number of questions are asked.

Supplied contexts are implicitly and dynamically randomized in two ways: first, through the random contraction of duplicate cases and second, through subsumptions using fuzzy matching.

Fuzzy matching uses qualitative weighting. This may be understood using the following example. Suppose, a first case is “a b d”, and “a c d” is a second case. There are no LHS subsumptions here. The number of LHS predicate instances is 4 (i.e., a, b, a, c). The predicate instance, a, is weighted 0.5 ( 2/4), while b and c are each weighted 0.25 (¼). Thus, the predicate instance, a, is a better fuzzy match here than are the predicate instances, b or c.

As noted above, context is matched with cases using, e.g., the case-based inference engine 120. To this end, the case-based inference engine 120 may be a most-specific inference engine to avoid error.

As part of context matching, the LHS situations having the greatest ratio in each group are compared. Each ratio is computed as the sum of the weights for each matched predicate (including duplicates) divided by the number of predicates or the number of situations in the group—whichever is greater. If the context exactly matches a LHS situation, the search for a best match is terminated. Ties are broken in favor of the most recent group and otherwise in favor of the headmost LHS situation, since cases are acquired at the head of their containing group.

The case-based inference engine 120 will stop context matching upon no change to the context, the receipt of an interrupt, or on a state just prior to the first occurrence of a cycle.

As noted above, case groups may be selected to be paired for transformation using uniform weighting or a 3-2-1-R skew. An example of a process for selecting a case in a group of cases from a case base using 3-2-1-R skew is shown in FIG. 4. The steps depicted in FIG. 4 illustrate advancement in selection of a “j^{th}” case in an “i^{th}” group in a list of groups. The steps shown in FIG. 4 are performed for all groups in a list of groups and all LHS situations in a selected group Gc.

As those skilled in the art will appreciate, the 3-2-1-R skew is a simple and fast technique for assigning cases relative weights on the basis of Denning's principle of temporal locality, where “R” stands for a uniform random skew within the outer 3-2-1 skew. This type of skew is used to increase the likelihood of solving a problem by taking full advantage of the current operational domain profile.

The selection of a particular skew is domain specific. For example, the rate of radioactive decay is known to be proportional to how much radioactive material is left (excluding the presence of certain metals). The nuclear decay equation may be used as a skew for various radioactive materials and is given by A(t)=A₀e^{-λt}. Here, A(t) is the quantity of radioactive material at time t, A₀=A(0) is an initial quantity, and λ (lambda) is a positive number (i.e., the decay constant) defining the rate of decay for the particular radioactive material. A countably infinite number of other skews may be applicable.

As noted above, a case is acquired at the logical list head and moved there when fired. A case is also expunged from the logical list tail when necessary to release space. The assumption is that more recently fired cases tend to be proportionately more valuable. Accordingly, in the assignment of skew-weights, the skew vector, S, favors the logical list head in keeping with temporal locality. Those case groups that are most recently acquired or fired, and thus appear at or nearer to the logical head of a list, are proportionately more heavily weighted using the 3-2-1-R skew. The closer a case group is to the head of its linked list, the greater its weight or importance. This differs from a uniform skew.

The 3-2-1-R skew is a heuristic scheme for assigning skew weights with a dependency category consisting of g groups. Referring to FIG. 4, the 3-2-1-R skew process 400 starts at step 410 at which a group number “i’ is set to 1 and case number “j” is set to 1. At step 420, cases are selected from the list of groups of cases for weighting using a uniform random number generator, e.g., the Mersenne Twister. With “i” and “j” initially each set to 1, a first case in a first group in a list is initially selected to be weighted most heavily. That is, the head group is assigned a group weight of:

$$\frac{2 g}{g ( g + 1 )}$$

The group just below the head group is assigned a weight of:

$$\frac{2 ( g - 1 )}{g ( g + 1 )}$$

The tail group of the list is assigned a weight of:

$$\frac{2}{g ( g + 1 )}$$

The ith group from the head group thus has a weight of:

$$\frac{2 ( g - i + 1 )}{g ( g + 1 )}$$

for i=1, 2, . . . , g, where, g specifies the number of case groups in the skew. Thus, for example, using a vector of four weights, the 3-2-1-R skew (S) is S=(0.4, 0.3, 0.2, 0.1)^{T}. There are a countably infinite number of possible skews, such that Σsₖ=1.0

At step 430, a determination is made whether there are any groups that have not been assigned weights, i.e., whether i is less than the number g of groups in the list. If there are groups remaining in the list, the skew advances through cases at step 440. Cases within groups are selected by uniform chance. The skew is advanced by incrementing j until all groups are considered for selection, when the number j of selected cases equals or exceeds the number of LHS situations in the current group Gc. This serves to slow down the skew's advancement, which results in favoring the most-recently acquired/fired cases in these same groups.

When all cases in all groups have been considered for selection, the process repeats unless an interrupt or wakeup occurs at step 450. In the event of an interrupt or wakeup, the process stops at step 460.

The use of the 3-2-1-R skew is optional, and other schemes, such as uniform weighting, may be used instead. The 3-2-1-R skew is useful for domains where the value of the data deteriorates in linear proportion to its time of collection, i.e., where more recent data is valued more highly. The use of additional time-dependent weights, depending on whether there is an additional time dependency of the value of the knowledge, is also possible.

The process depicted in FIG. 4 may be performed by a computing device that is external to or included as part of the computer source code synthesizer 125 shown in FIG. 1. The computing device for performing the skew may be similar to that shown in FIG. 5 and described below.

FIG. 5 is a block diagram of a computing device 500 with which various components of the cyber secure automatic programming system 100, e.g., components of the computer source code synthesizer 125 and/or components of the cyber-security validator 150, may be implemented. The computing device 500 also represents a device for selecting case groups to be paired for transformation using uniform weighting or a 3-2-1-R skew according to illustrative embodiments. Although no connections are shown between the components illustrated in FIG. 5, those skilled in the art will appreciate that the components can interact with each other via any suitable connections to carry out device functions.

The term “application”, or variants thereof, is used expansively herein to include routines, program modules, program, components, data structures, algorithms, and the like. Applications can be implemented on various system configurations, including single-processor or multiprocessor systems, minicomputers, mainframe computers, personal computers, handheld-computing devices, microprocessor-based, programmable consumer electronics, combinations thereof, and the like. The terminology “computer-readable media” and variants thereof, as used in the specification and claims, includes non-transitory storage media. Storage media can include volatile and/or non-volatile, removable and/or non-removable media, such as, for example, RAM, ROM, EEPROM, flash memory or other memory technology, CDROM, DVD, or other optical disk storage, magnetic tape, magnetic disk storage, or other magnetic storage devices or any other medium that can be used to store information that can be accessed.

Referring to FIG. 5, the computing device 500 includes a processor 510 that receives inputs and transmits outputs via input/output (I/O) Data Ports 520. The I/O Data Ports 520 can be implemented with, e.g., any suitable interface through which data may be received and transmitted wired and/or wirelessly. For example, in the case of the computing device 500 used in the computer source code synthesizer 125 shown in FIG. 1, the inputs may include parameters, context, etc. Outputs may include, for example, queries for parameters or context and generated computer source codes.

Although not shown, the computing device 500 may also include a physical hard drive. The processor 510 communicates with the memory 530 and the hard drive via, e.g., an address/data bus (not shown). The processor 510 can be any commercially available or custom microprocessor. The memory 530 is representative of the overall hierarchy of memory devices containing the software and data used to implement the functionality of the computing device 500. The memory 530 can include, but is not limited to the types of memory devices described above. As shown in FIG. 5, the memory 530 may include several categories of software and data used in the computing device 500, including applications 540, a database 550, an operating system (OS) 560, etc.

The applications 540 can be stored in the memory 530 and/or in a firmware (not shown) as executable instructions, and can be executed by the processor 510. The applications 540 include various programs that implement the various features of the computing device 500. For example, in the case of the cyber-secure automatic programming system shown in FIG. 1, the applications 540 may include applications to implement the functions of the case-based inference engine 120 and/or the cyber-security validator 150.

The database 550 represents the static and dynamic data used by the applications 540, the OS 560, and other software programs that may reside in the memory. The database 550 may be used to store various data including data needed to execute the applications 540. For example, in the case of the computer source code synthesizer 125 shown in FIG. 1, the database 550 may store, e.g., cases, computer source code components, etc. Although one database 550 is shown, it should be appreciated that the database 550 represents one or more databases that correspond to the case database 130 and the computer source code components database 140 shown in FIG. 1.

While the memory 530 is illustrated as residing proximate the processor 510, it should be understood that at least a portion of the memory 530 can be a remotely accessed storage system, for example, a server on a communication network, a remote hard disk drive, a removable storage medium, combinations thereof, and the like.

It should be understood that FIG. 5 and the description above are intended to provide a brief, general description of a suitable environment in which the various aspect of some embodiments of the present disclosure can be implemented. While the description includes a general context of computer-executable instructions, the present disclosure can also be implemented in combination with other program modules and/or as a combination of hardware and software in addition to, or instead of, computer readable instructions.

Further, although FIG. 5 shows an example of a computing device with components of the cyber-secure automatic programming system 100 may be implemented, those skilled in the art will appreciate that there may be other computer system configurations, including, for example, multiprocessors, parallel processors, virtual processors, distributed computing systems, microprocessors, mainframe computers, and the like.

According to the illustrative embodiments described above, pseudo-validation and cyber-security may be realized by one or more computer source code synthesizers running in parallel, setting the RHS action of each, resulting from the output of each synchronized LHS situation firing, to be substantially the same (i.e., to produce the same desired result). Non-determinism is not permitted here because it would then be impossible or intractable to compare the outputs going forward. This serves pseudo-validation and cyber security through semantically equivalent variants of computer source code. Situations, supported by functional computer source code components, are coordinated to produce actions, supported by procedural computer source code components. An attack (or insufficient training) is detected if any of the multitude of system outputs, which should be identical, are not. No a priori knowledge of the form or type of cyber-attack is required to successfully defend against it.

Semantic randomization of computer source code, i.e., the use of distinct semantically equivalent variants of computer source code, provides greater protection than syntactic diversity of object code, as cyber-attacks can only affect, at most, one computer source code variant at a time. By contrast, cyber-attacks are expected to be able to succeed against multiple versions of object code simultaneously.

According to illustrative embodiments, symmetric knowledge is used in the generation of semantically equivalent variants of computer source code. Randomization is used to maximize the reuse of constituent cases. This minimizes the time required for detecting a cyber-attack.

Further, as described above, massively parallel (distributed) processors may store and simultaneously search for matching cases in a case base to find a best match. A linear increase in the number of processors used to match cases in a case database provides exponential increases in cyber-security. Additionally, the use of massively parallel processors supports the development of ever-more complex software and heuristic programming to achieve supra-quantum computer computational speeds.

It will be understood that many additional changes in the details, materials, steps and arrangement of parts, which have been herein described and illustrated to explain the nature of the invention, may be made by those skilled in the art within the principle and scope of the invention as expressed in the appended claims.

What is claimed is:

1. A computing device, comprising:
a user interface configured to:
receive, from a user, a first parameter associated with a desired result; and
receive, from the user or another user, a second parameter associated with the desired result, wherein the first parameter is different than the second parameter; and
a case-based inference engine including at least one processor, wherein the case-based inference engine is configured to:
generate first computer source code based on the first parameter; and
generate second computer source code based on the second parameter, wherein the second computer source code is generated as a semantically equivalent variant of the first computer source code to provide for protection against a cyber-attack.

2. The computing device of claim 1, wherein the first parameter and the second parameter are received responsive to a first query and a second query, respectively.

3. The computing device of claim 1, further comprising a case database configured to store cases.

4. The computing device of claim 3, wherein each case includes a situation and an action.

5. The computing device of claim 3, wherein the first parameter is associated with at least one first case stored in the case database, and the second parameter is associated with at least one second case stored in the case database.

6. The computing device of claim 5, wherein the case-based inference engine is configured to select the at least one first case associated with the first parameter and select the at least one second case associated with the second parameter from the case database.

7. The computing device of claim 5, wherein the at least one first case is associated with first computer source code components, and wherein the at least one second case is associated with second computer source code components.

8. The computing device of claim 7, wherein the case-based inference engine is configured to assemble the first computer source code components into the first computer source code and assemble the second computer source code components into the second computer source code.

9. A computer-based method, comprising:
receiving, via a user interface, a first parameter associated with a desired result;
generating, by a case-based inference engine, first computer source code by selecting at least one first case associated with first computer source code components based on the first parameter;
receiving, via the user interface, a second parameter associated with the desired result, wherein the first parameter is different from the second parameter;
generating, by the case-based inference engine, second computer source code by selecting at least one second case associated with second computer source code components based on the second parameter, wherein the second computer source code is generated as a semantically equivalent variant of the first computer source code to provide for protection against a cyber-attack.

10. The method of claim 9, wherein the at least one first case is selected from cases stored in a case database based on the first parameter.

11. The method of claim 10, wherein the at least one second case is selected from the cases stored in the case database based on the second parameter.

12. The method of claim 9, wherein the at least one second case is different than the at least one first case.

13. The method of claim 9, wherein generating the first computer source code further includes assembling the first computer source code components into the first computer source code.

14. The method of claim 9, wherein generating the second computer source code further includes assembling the second computer source code components into the second computer source code.

15. A computer-based system, comprising:
a user interface configured to receive a first parameter associated with a desired result and a second parameter associated with the desired result, wherein the first parameter is different than the second parameter;
a case database configured to store cases;
a case-based inference engine configured to:
generate first computer source code by selecting at least one first case from the case database based on the first parameter, wherein the at least one first case is associated with first computer source code components; and
generate second computer source code by selecting at least one second case from the case database based on the second parameter, wherein the at least one second case is associated with second computer source code components, and wherein the second computer source code is generated as a semantically equivalent variant of the first computer source code to provide for protection against a cyber-attack.

16. The computer-based system of claim 15, wherein the case-based inference engine includes a first processor and a second processor that are configured to generate the first computer source code and the second computer source code, respectively.

17. The computer-based system of claim 15, further comprising a computer source code component database configured to store a plurality of computer source code components.

18. The computer-based system of claim 17, wherein the case-based inference engine is configured to select the first computer source code components associated with the at least one first case and select the second computer source components associated with the at least one second case from among the plurality of computer source code components stored in the computer source code component database.

19. The computer-based system of claim 18, wherein the case-based inference engine is configured to assemble the first computer source code components, selected from the computer source code component database, into the first computer source code.

20. The computer-based system of claim 18, wherein the case-based inference engine is configured to assemble the second computer source code components, selected from the computer source code component database, into the second computer source code.
